(19) United States
(12) Patent Application Publication
(10) Pub. No.: US 2025/0167536 A1
(43) Pub. Date: May 22, 2025

(54) APPARATUS, SYSTEM, AND METHOD FOR PROVIDING EVENT INDICATION

(71) Applicant: Schneider Electric USA, Inc., Andover, MA (US)

(72) Inventors: Randy William Blake, Vinton, IA (US); Daniel Gene Hollinger, Cedar Rapids, IA (US); Clinton Neal Carne, North Liberty, IA (US); Cameron Lee Woodson, Cedar Rapids, IA (US)

(73) Assignee: Schneider Electric USA, Inc., Boston, MA (US)

(21) Appl. No.: 18/841,886

(22) PCT Filed: Mar. 3, 2023
(86) PCT No.: PCT/US2023/014421

§ 371 Date: Aug. 27, 2024

Related U.S. Application Data
(60) Provisional application No. 63/316,782, filed on Mar. 4, 2022.

(51) Int. Cl. H02H 3/04

(52) U.S. Cl. CPC H02H 3/04

(57) ABSTRACT

Apparatuses, systems, and methods are described for providing event indication. The system includes a protection device, an event indicator associated with the protection device, including a housing having an opening; a translation member configured to extend at least partially through the opening, and a detection section configured to generate a position signal based at least in part upon a position of the translation member, and a connector section configured to transmit the position signal. The system further includes an external device communicatively coupleable to the connector section to obtain the position signal.

### RELATED APPLICATION

The present application claims priority to U.S. Provisional Patent Application Ser. No. 63/316,782, filed on Mar. 4, 2022, and entitled APPARATUS, SYSTEM, AND METHOD FOR PROVIDING EVENT INDICATION, which is incorporated by reference herein in its entirety.

### TECHNICAL FIELD

The present disclosure relates to providing indication that an event has occurred, and more particularly, to providing apparatuses, systems, and methods for providing event indication.

### BACKGROUND

Conventional electrical protection systems suffer drawbacks caused by mitigating events such as line side cross phase issues and arc flashes in a manner such that detection of the event is not readily apparent absent direct physical inspection of the protection system. Such protection systems may be used to protect against events such as line side cross phase or ground fault arcing events by self-clearing without dropping the load. This can lead to problems associated with debris and damage not being detected, as well as needed maintenance not being performed. For example, a protection device may clear an event without dropping the load, thereby preventing identification of the event's occurrence. An end user will thus not know that the event has occurred, and that inspection and maintenance of a protection device should be scheduled.

### SUMMARY

Implementations consistent with the present disclosure address the problems identified above, amongst others. Implementations consistent with the present disclosure may provide apparatuses, systems, and methods for providing an event indicator.

An event indicator may include an actuation section, a detection section, and a connector section. The actuation section may include a plunger within an opening through a housing of the event indicator. An external force, such as a pressure force caused by mitigation of an arc flash event by a protection device, may cause the plunger to move within the opening through the housing of the event indicator. The detection section includes a sensor (such as a microswitch) which detects a position of the plunger within the opening and generates a signal relating to the detected position of the plunger. The signal is provided to the connector section of the event indicator, where it may be provided to an external device, such as a Programmable Logic Controller (PLC) and/or a supervisory control and data acquisition (SCADA) control system or element thereof, an alarm light to provide visual indicia, a local counter to count an event number, or combination thereof. The plunger of the event indicator is arranged to maintain a default state until an event occurs, and the plunger is transitioned to an alert state. The plunger may remain in the alert state until the plunger is manually reset to the default state, for example by manually pushing the plunger back into the event indicator. The plunger may be made of a lightweight material so as to provide fast event indication when an external force is received.

The plunger used in conjunction with a switch, such as an electrical switch (e.g., microswitch) provides an event indicator which allows a visual plunger indication at an external surface of the event indicator (such as a front surface of the device). The event indicator may provide a microswitch dry contact output that can be connected to any remote monitoring digital system or other element such as alarm light, counter, or other element via the connector section to provide the remote signal that an event occurred. The microswitch may be configured to provide digital output which is communicatively coupleable to any management system or other element communicatively coupleable to the event indicator.

An event indicator may include a plunger with microswitch type accessory that is mounted to a surface such as an outer surface of a cable vault and may be actuated from the pressure of a protection event. During actuation, the microswitch may change state, for example via dry contacts changing state. The plunger may be used as a visual indicator on the front of the event indicator. The microswitch (e.g., at dry contacts thereof) can be connected to any monitoring system to indicate remotely that an event has occurred. Inspection, maintenance, and cleaning can then be scheduled for the protection device that had the event occur. After inspection, maintenance, and cleaning the event indicator may be reset by manually pushing the plunger back into the housing of the event indicator (e.g., restoring the plunger to a default, flush orientation relative to an outer surface of the event indicator).

According to a first aspect of the present disclosure, provided is an event indicator. The event indicator includes a housing having an opening, a translation member configured to extend at least partially through the opening; and a detection section configured to generate a position signal based at least in part upon a position of the translation member.

According to another aspect of the present disclosure, provided is a system for providing event indication. The system includes a protection device, an event indicator associated with the protection device, including a housing having an opening; a translation member configured to extend at least partially through the opening, and a detection section configured to generate a position signal based at least in part upon a position of the translation member, and a connector section configured to transmit the position signal. The system further includes an external device communicatively coupleable to the connector section to obtain the position signal.

Still further aspects of the present disclosure relate to a method for providing event indication. The method includes receiving a force, transporting a detection element responsive to the received force, determining a position of the detection element to determine a status condition, and selectively generating an event signal when the event status indicates that an event condition exists based at least in part upon the status condition.

Implementations consistent with the present disclosure provide a plunger-type fast acting indicator actuated by a pressure pulse of an interruption inside a protection device. The plunger may be light enough that the short duration pressure pulse will cause the plunger to move. Features on the plunger may actuate a sensor such as a microswitch as the plunger moves through at least a portion of the event indicator. The outside surface of the plunger may be a bright color to be more noticeable when actuated. To reset the device after inspection and maintenance have been done, the plunger may be pushed back in manually.

Numerous other objects, features, and advantages of the present invention will be readily apparent to those skilled in the art upon a reading of the following disclosure when taken in conjunction with the accompanying drawings

### BRIEF DESCRIPTION OF THE DRAWINGS

FIG. 1 illustrates a block diagram of an embodiment of an event indicator according to aspects of the present disclosure.

FIG. 2 illustrates a rear raised perspective exploded view of an embodiment of an event indicator according to aspects of the present disclosure.

FIG. 3 illustrates a partial top view of an embodiment of an event indicator mounted to a surface and illustrates a simplified partial front view of internal components of an embodiment of an event indicator according to aspects of the present disclosure.

FIG. 4 illustrates a block diagram of an embodiment of a system configuration for providing event indication according to aspects of the present disclosure.

FIG. 5A illustrates a partial raised front right perspective view of an embodiment of an event indicator having a translation member in a default state according to aspects of the present disclosure.

FIG. 5B illustrates a partial internal left side view of an embodiment of an event indicator whose translation member is in a default state according to aspects of the present disclosure.

FIG. 6A illustrates a partial raised front right perspective view of an embodiment of an event indicator having a translation member in an alert state according to aspects of the present disclosure.

FIG. 6B illustrates a partial internal left side view of an embodiment of an event indicator whose translation member is in an alert state according to aspects of the present disclosure.

FIG. 7 illustrates an embodiment of a flowchart depicting a process for providing event indication according to aspects of the present disclosure.

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

Identical reference numerals have been used, where possible, to designate identical elements that are common to the figures. However, elements disclosed in one embodiment may be beneficially utilized on other embodiments without specific recitation.

### DETAILED DESCRIPTION

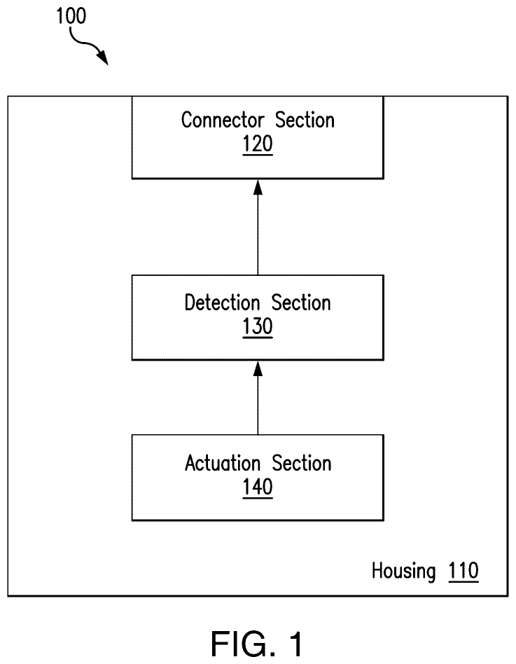

FIG. 1 illustrates a block diagram of an embodiment of an event indicator according to aspects of the present disclosure. The event indicator 100 includes one or more of a housing 110, a connector section 120, a detection section 130, and/or an actuation section 140. The housing 110 may be coupleable to a surface, for example a cable vault cover. The connector section 120 includes one or more elements configured to permit signals or data to be transmitted from the event indicator 100. In various embodiments, the connector section 120 includes a terminal configured to couple to one or more conductive elements external to the event indicator 100, such as a wired connection to a Programmable Logic Controller (PLC) and/or a wired or wireless connection to a supervisory control and data acquisition (SCADA) control system or element thereof, an alarm light to provide visual indicia, a local counter to count an event number, or combination thereof. Additionally or alternatively, the connector section 120 may provide one or more wired and/or wireless communication interfaces for transmitting data from the event indicator 100 and/or for receiving data at the event indicator 100.

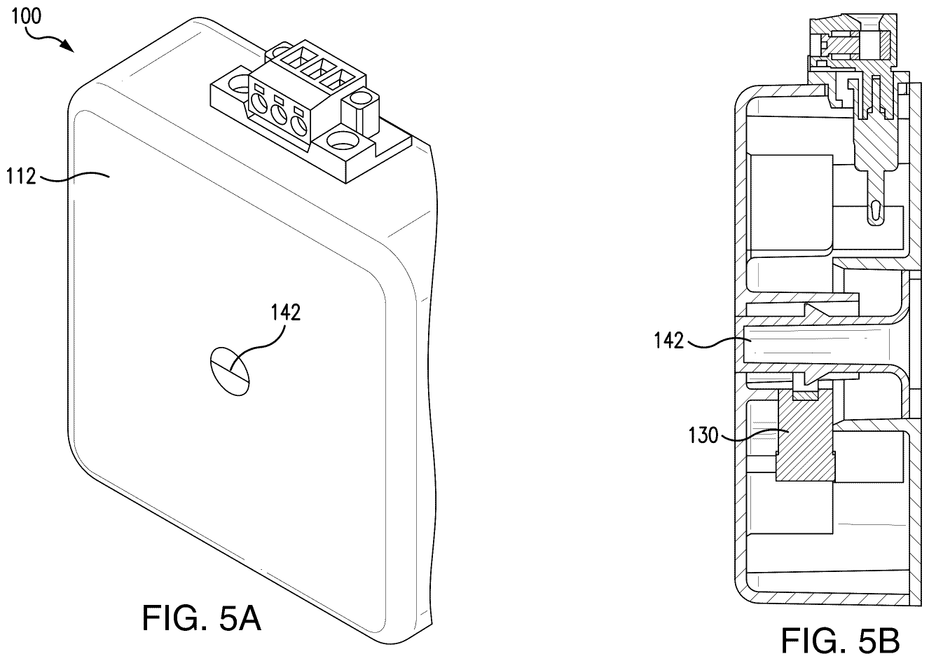

The event indicator 100 may include an actuation section 140 having one or more elements configured to indicate an event condition. For example, the actuation section may include a translatable member configured to change position based at least in part to a stimulus caused by an event condition. The translatable member may be a plunger (e.g., plunger 142) configured to move within an opening through at least a portion of the housing 110 of the event indicator 100. Movement of the translatable member may be caused by an external stimulus, for example a pressure force caused by an event condition. The external stimulus caused by the event condition may cause the translatable member to change position, for example by moving relative to at least one component of the housing 110 (e.g., by shifting within the opening of the housing 110). Movement of the translatable member may cause a visual indicia of an event condition. For example, the translatable member may be located flush with an outer surface of the housing 110 or at least partially internal to the housing 110 as a default state, and may be configured to extend outwards from the outer surface of the housing 110 when an event condition causes the translation member to transition to an alert state. Additional description of operation of the translatable member is described herein with reference to FIGS. 5A-B and 6A-B.

The event indicator 100 may further include a detection section 130. The detection section 130 may include one or more elements configured to obtain one or more parameters associated with the actuation section and to selectively provide one or more corresponding signals to the connector section 120. The detection section 130 may include a switching element, such as a microswitch, which is configured to provide a signal (e.g., digital signal) corresponding to a position of a translatable member of the actuation section 140. For example, the switching element may open or close a switch based at least in part upon a position/location of a translatable member of the actuation section 140. This signal may be conveyed to the connector section 120, for example via a conductive bus such as a wire.

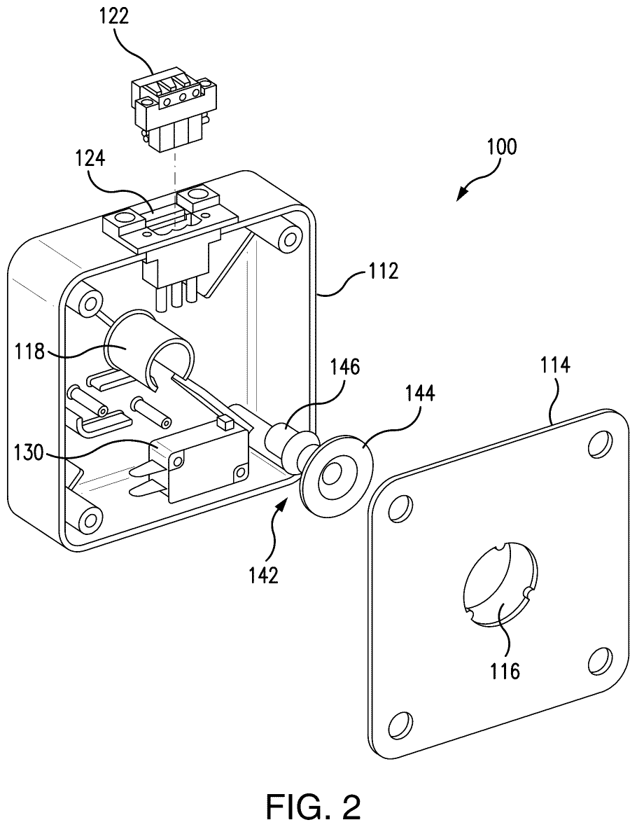

FIG. 2 illustrates a rear raised perspective exploded view of an embodiment of an event indicator according to aspects of the present disclosure. The event indicator 100 includes a front section 112 and a rear section 114 of a housing 110, a first connector portion 122 and a second connector portion 124 of a connector section 120, a detection section 130, and a plunger 142 of an actuation section 140. Although illustrated as part of the event indicator 100, it should be appreciated that the first connector portion 122 may be a connector which is coupleable to the second connector portion 124, for example as part of an external element coupleable to the event indicator 100 via the second connector portion 124. The rear section 114 includes a first opening 116 through a portion thereof and which is configured to correspond to the plunger 142 of the actuation section 140 and to permit movement of the plunger 142 within the first opening 116 (for example, responsive to an event condition). The plunger 142 may include a flared portion 144 at an end corresponding to the first opening 116 and having a corresponding diameter configured to be received within the first opening 116. Although illustrated and described as being flared, the flared portion 144 may additionally or alternatively relate to any section having a different outer diameter than another section of the plunger 142 without departing from the spirit and scope of the present disclosure. A guide 118 may be provided at the housing 110 having a smaller diameter than the first opening 116 which is configured to receive at least a portion of the plunger 142 (e.g., at a first portion 146 of the plunger 142) and to restrict movement of the plunger 142, for example during an event condition. The guide 118 may be configured such that a portion of the plunger 142 may pass therethrough (e.g., associated with the first portion 146) but will restrict movement of the flared portion of the plunger 142.

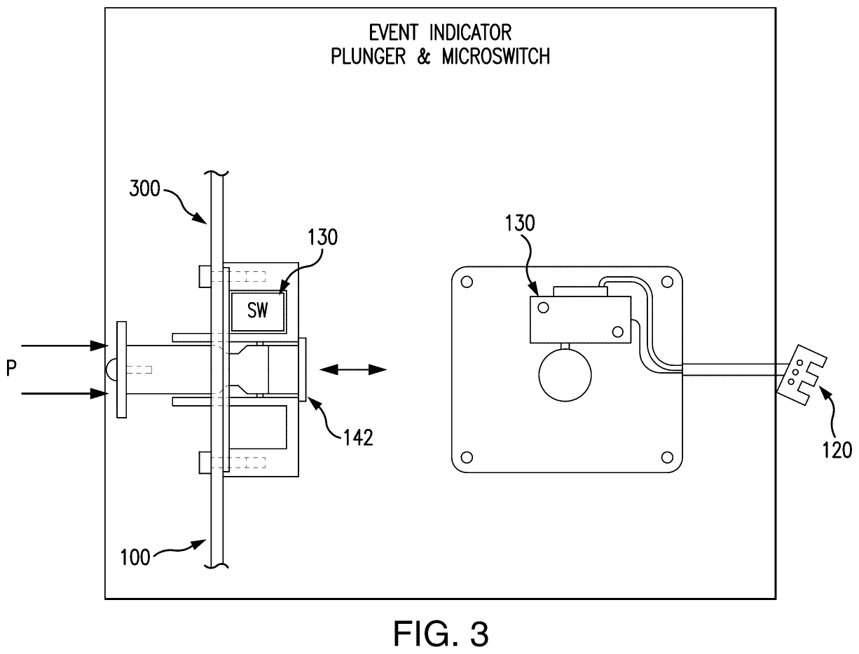

FIG. 3 illustrates a partial top view of an embodiment of an event indicator 100 mounted to a surface 300 and illustrates a simplified partial front view of internal components of an embodiment of an event indicator 100 according to aspects of the present disclosure. As seen in the top view at the left portion of FIG. 3, the event indicator 100 may be mounted to a surface 300. The surface 300 may be a cable vault cover in various embodiments. The plunger 142 may be configured to translate within an internal opening of the event indicator 100 and to translate a pressure force P to cause the plunger 142 to move outward from a surface of the event indicator 100 (e.g., a front surface in the direction of pressure force P illustrated by FIG. 3). As shown by the partial front internal view of the event indicator 100 illustrated at the right side of FIG. 3, a switching element of a detection section 130 may be housed within the event indicator 100 and configured to detect a position of the plunger 142 within an opening which extends through at least a portion of an interior space of the event indicator 100. The switching element of detection section 130 may be communicatively coupled to the connector section 120 (e.g., via one or more conductive wires).

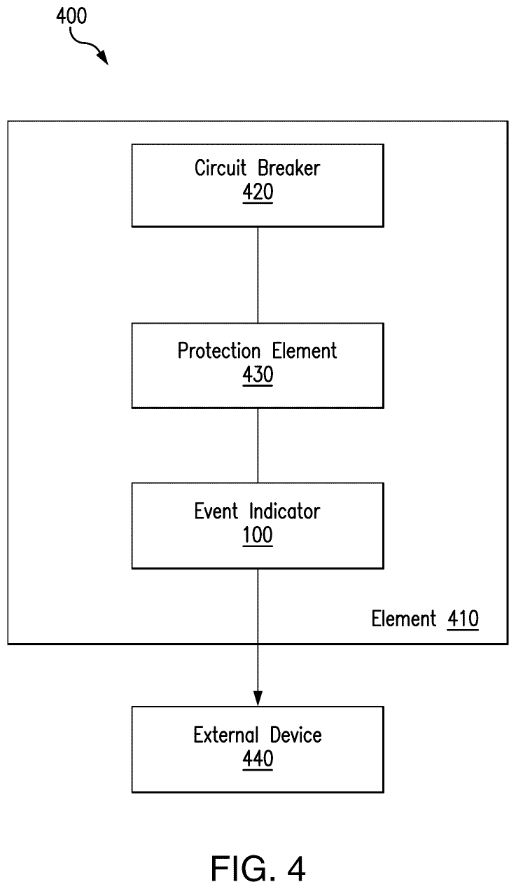

FIG. 4 illustrates a block diagram of an embodiment of a system configuration for providing event indication according to aspects of the present disclosure. The system 400 includes an element 410. The element 410 may be a structural element in various embodiments, such as a cable box. Although illustrated as a single box, it should be appreciated that one or more components of element 410 may be physically separate from one another, such as being mounted to different physical structures associated with an element 410. Additionally or alternatively, multiple elements 410 may be combined to be viewed as an element 410. The element 410 may include one or more of a circuit breaker 420, a protection element 430, and/or an event indicator 100. The circuit breaker 420 may be coupleable to a power source and configured to protect against input power issues such as overcurrent, short circuit, or other power issues. The protection element 430 may include one or more protection devices configured to provide safety functions. The protection element 430 may provide one or more prevention or mitigation functions relating to, for example, line side cross phase or ground fault arcing events (e.g., by self-clearing without dropping the load). During operation, an event condition may be mitigated by the protection element 430 such that a failure is prevented, and the underlying event is thus not easily ascertained. The event indicator 100 may be configured to provide an indication of the event condition in the manner previously described, for example by causing a position of the plunger 142 of the actuation section 140 of the event indicator 100 to be translated from a default state corresponding to a first plunger location to an alert state corresponding to a second plunger location responsive to a pressure pulse caused by the event condition (e.g., as generated by the protection element as a result of the event condition).

The event indicator 100 may be communicatively coupleable to an external device 440, for example via the connector section 120 of the event indicator 100. The external device 440 may be any device capable of receiving information from the event indicator 100. In various embodiments, the external device 440 is a Programmable Logic Controller (PLC). Additionally or alternatively, the external device 440 may be or include a SCADA control system or element thereof, for example configured to receive one or more sets of data associated with the event indicator 100 and to selectively perform one or more operations associated with the event indicator 100. A switching element of the detection section 130 may determine a position of a translation member (e.g., plunger 142) of the event indicator 100 to determine a status condition, and may selectively generate an event signal when the event status indicates that an event condition exists based at least in part upon the status condition. The event signal may be provided to the connector section 120 and selectively transmitted to the external device 440. In various embodiments, communication(s) between the event indicator 100 and the external device 440 may be performed via wired and/or wireless communications and corresponding interfaces and may include private and/or public networks without departing from the spirit and scope of the present disclosure. In some embodiments, the event signal may be provided via wired communication to a PLC from the event indicator 100 via the connector section 120. Additionally or alternatively, the event signal may be provided via wired and/or wireless communication to a SCADA control system or element thereof.

FIG. 5A illustrates a partial raised front right perspective view of an embodiment of an event indicator 100 having a translation member in a default state. FIG. 5B illustrates a partial internal left side view of an event indicator 100 whose translation member is in a default state. As illustrated by FIGS. 5A-B, while a translation member (such as a plunger 142) operates at a default state, the translation member remains either flush with an outer surface of the event indicator 100 or within an interior space of the event indicator 100.

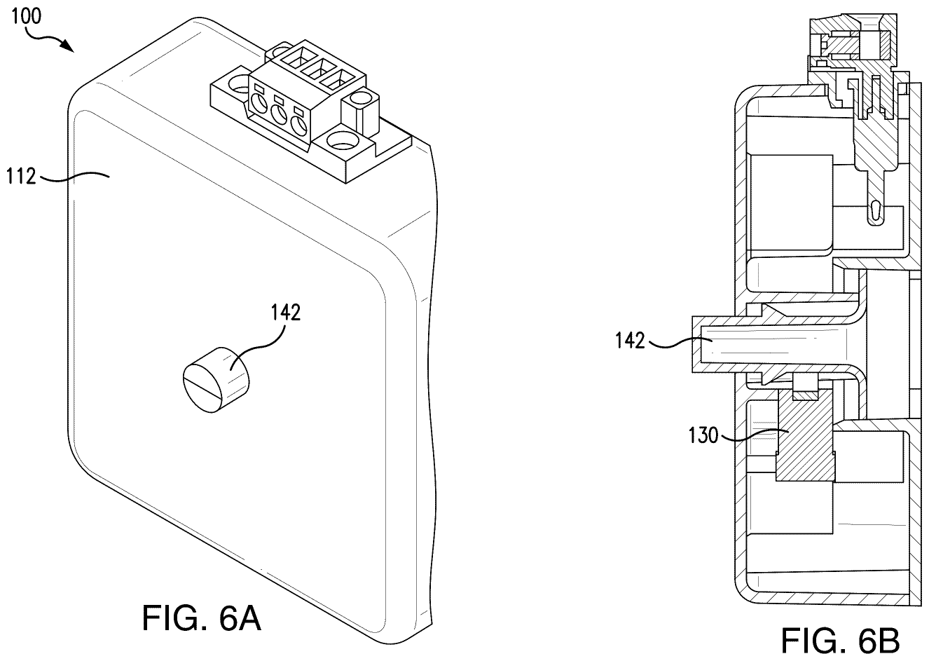

FIG. 6A illustrates a partial raised front right perspective view of an embodiment of an event indicator 100 having a translation member in an alert state. FIG. 6B illustrates a partial internal left side view of an event indicator 100 whose translation member is in an alert state. As illustrated by FIGS. 6A-B, while a translation member (such as a plunger 142) operates at an alert state, at least a portion of the translation member extends outwardly from a surface of the event indicator 100. During operation, the event indicator 100 may be transitioned to the alert state when an external force, such as a pressure pulse, is received at the opening 116 of the event indicator 100 which causes the translation member of the event indicator (e.g., plunger 142) to be moved into the opening 116 and thus outward from a surface (e.g., front outer surface) of the event indicator 100. The event indicator 100 may be returned to the default state (e.g., after inspection or maintenance) by manually pushing the portion of the translation member extending outwardly from a surface of the event indicator 100 to back to a flush position relative to the surface of the event indicator 100 or further therein.

An event indicator 100 may include one or more of a housing 110 having an opening 116, a translation member (e.g., a plunger 142 of an actuation section 140) configured to extend at least partially through the opening 116, and/or a detection section 130 configured to generate a position signal based at least in part upon a position of the translation member. The event indicator 100 may include a connector (e.g., of a connector section 120) communicatively coupleable to the detection section 130, the connector being configured to transmit the position signal. The translation member may be configured to move within the opening 116 responsive to a force received at the translation member. The translation member may include at least one reference section (e.g., the first portion 146 of the plunger 142). The detection section 130 may generate the position signal based at least in part upon a location of the reference section relative to a switching element of the detection section. The reference section may include one or more ridges, valleys, flared sections, or ramps at an outer surface of the translation member. The one or more ridges, valleys, flared sections, or ramps may be sensed by the switching element of the detection section 130 to determine the position of the translation member relative to at least a portion of the event indicator. The switching element may be a microswitch configured to determine the position of the translation member according to sensing the one or more ridges, valleys, flared sections, or ramps.

As described herein. a system for providing event indication may include a protection device (e.g., protection element 430), an event indicator 100 associated with the protection device, including a housing 110 having an opening 116, a translation member (e.g., a plunger 142 of an actuation section 140) configured to extend at least partially through the opening 116, a connector section configured to transmit the position signal, and/or a detection section 130 configured to generate a position signal based at least in part upon a position of the translation member. The system may further include an external device 440 communicatively coupleable to the connector section 120 to obtain the position signal. The translation member may be configured to move within the opening 116 responsive to a force received by the translation member. The translation member may include at least one reference section. The detection section 130 may generate the position signal based at least in part upon a location of the reference section relative to a switching element of the detection section. The reference section may include one or more ridges, valleys, flared sections, or ramps at an outer surface of the translation member. The one or more ridges, valleys, flared sections, or ramps may be sensed by the switching element of the detection section 130 to determine the position of the translation member relative to at least a portion of the event indicator. The switching element may be a microswitch configured to determine the position of the translation member according to sensing the one or more ridges, valleys, flared sections, or ramps. The protection device may be configured to mitigate an electrical event and to generate a corresponding pressure pulse. The translation member is configured to move within the opening of the event indicator responsive to the pressure pulse received at the translation member.

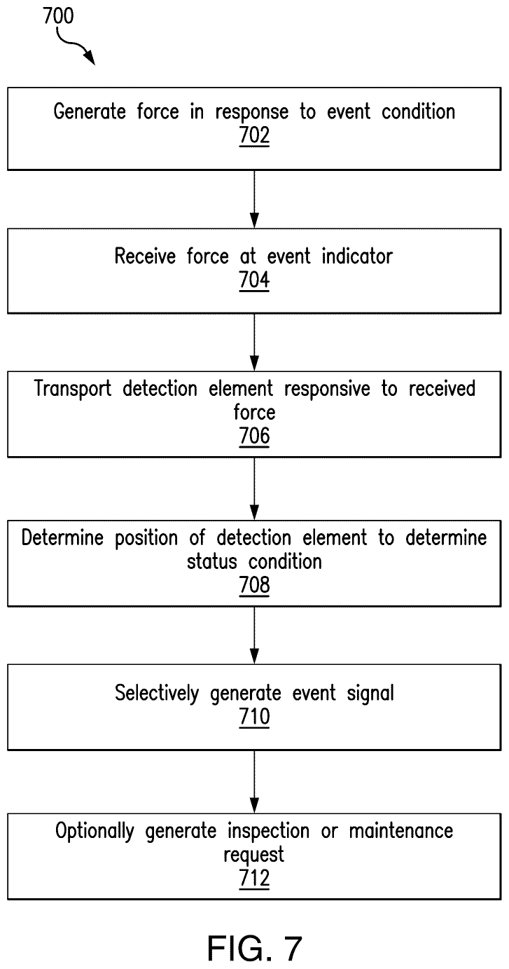

FIG. 7 illustrates an embodiment of a flowchart depicting a process for providing event indication according to aspects of the present disclosure. The process 700 includes an operation 702 to generate a force in response to an event condition. The generated force may be a pressure pulse in various embodiments. The force may be generated based at least in part upon at least one mitigation operation performed by a protection device, such as at least one operation relating to line side cross phase or ground fault arcing events. The generated force is received at an event indicator at an operation 704. The event indicator may be an event indicator 100 previously described herein or portion thereof. A detection element may cause a detection element to move at an operation 706 based at least in part upon the received force. This may include movement of a translation member, such as a plunger 142, of an actuation section 140 responsive to a force received at the operation 704. At an operation 708 a position of the detection element may be determined, for example using a sensing element of the detection section 130, such as a microswitch. An event signal relating may be generated at an operation 710 when an event condition is identified based at least in part upon the determined position of the detection element. At least one inspection or maintenance request or flag may optionally be generated at an operation 712 when an alert status is determined to have occurred in relation to an event indicator 100. After completion of any inspection or maintenance operation, the detection element or portion thereof may be returned to a default (e.g., non-alert) state by adjusting a position of the detection element. This may include pushing at least a portion of the detection element into the event indicator 100 or portion thereof in various embodiments.

According to methods for providing event indication one or more operations may include receiving a force, transporting a detection element (e.g., a plunger 142 of an actuation section 140) responsive to the received force, determining a position of the detection element to determine a status condition, and selectively generating an event signal when the event status indicates that an event condition exists based at least in part upon the status condition. The force may be a pressure pulse. The methods may include generating the force by a protection device responsive to an event condition. Translating the position of the detection element based upon the received force may include causing the detection element to move within an opening of an event indication device. One or more methods may include optionally generating an inspection or maintenance request based at least in part upon the status condition.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. An event indicator, comprising:
a housing having an opening;
a translation member configured to extend at least partially through the opening; and
a detection section configured to generate a position signal based at least in part upon a position of the translation member.

2. The event indicator of claim 1, further comprising:
a connector communicatively coupleable to the detection section, the connector configured to transmit the position signal.

3. The event indicator of claim 1, wherein the translation member is a plunger configured to move within the opening responsive to a force received by the plunger.

4. The event indicator of claim 3, wherein the plunger includes at least one reference section, and further wherein the detection section includes a switching element and is configured to generate the position signal based at least in part upon a location of the reference section relative to the switching element.

5. The event indicator of claim 4, wherein the reference section includes one or more ridges, valleys, flared sections, or ramps at an outer surface of the plunger, the one or more ridges, valleys, flared sections, or ramps configured to be sensed by the switching element to determine the position of the translation member.

6. The event indicator of claim 5, wherein the switching element is a microswitch configured to determine the position of the translation member according to sensing the one or more ridges, valleys, flared sections, or ramps.

7. The event indicator of claim 1, wherein the detection section includes an electrical switch.

8. A system for providing event indication, the system comprising:
a protection device;
an event indicator associated with the protection device, including
a housing having an opening;
a translation member configured to extend at least partially through the opening;
a detection section configured to generate a position signal based at least in part upon a position of the translation member; and
a connector section configured to transmit the position signal; and
an external device communicatively coupleable to the connector section to obtain the position signal.

9. The system of claim 8, wherein the translation member is a plunger configured to move within the opening responsive to a force received by the plunger.

10. The system of claim 9, wherein the plunger includes at least one reference section, and further wherein the detection section includes a switching element and is configured to generate the position signal based at least in part upon a location of the reference section relative to the switching element.

11. The system of claim 10, wherein the reference section includes one or more ridges, valleys, flared sections, or ramps at an outer surface of the plunger, the one or more ridges, valleys, flared sections, or ramps configured to be sensed by the switching element to determine the position of the translation member.

12. The system of claim 11, wherein the switching element is an electrical switch configured to determine the position of the translation member according to sensing the one or more ridges, valleys, flared sections, or ramps.

13. The system of claim 8, wherein the detection section includes an electrical switch.

14. The system of claim 8, wherein the protection device is configured to mitigate an electrical event and to generate a corresponding pressure pulse.

15. The system of claim 14, wherein the translation member is configured to move within the opening of the event indicator responsive to the pressure pulse received at the translation member.

16. A method for providing event indication, the method comprising:
receiving a force;
transporting a detection element responsive to the received force;
determining a position of the detection element to determine a status condition; and
selectively generating an event signal when the event status indicates that an event condition exists based at least in part upon the status condition.

17. The method of claim 16, wherein the force is a pressure pulse.

18. The method of claim 16, further comprising:
generating the force by a protection device responsive to an event condition.

19. The method of claim 18, wherein the force is a pressure pulse.

20. The method of claim 16, wherein the transporting the detection element responsive to the received force includes causing the detection element to move within an opening of an event indication device.

21. The method of claim 16, further comprising:
generating an inspection or maintenance request based at least in part upon the status condition.
